(19) United States
(12) Patent Application Publication
(10) Pub. No.: US 2017/0015088 A1
(43) Pub. Date: Jan. 19, 2017

(54) LAMINATE

(71) Applicant: KURARAY CO., LTD., Kurashiki-shi (JP)

(72) Inventor: Yusaku NOMOTO, Tainai-shi (JP)

(73) Assignee: KURARAY CO., LTD., Kurashiki-shi (JP)

(21) Appl. No.: 15/124,085

(22) PCT Filed: Mar. 4, 2015
(86) PCT No.: PCT/JP2015/056387

§ 371 Date: Sep. 7, 2016

(30) Foreign Application Priority Data
Mar. 7, 2014 (JP) 2014-045085
Jun. 25, 2014 (JP) 2014-129796

(51) Int. Cl. B32B 27/36; B32B 27/30; B32B 27/08

(52) U.S. Cl. CPC B32B 27/365; B32B 27/08; B32B 27/308; B32B 2307/306; B32B 2307/412; B32B 2307/554; B32B 2307/584; B32B 2551/00; B32B 2605/00; B32B 2605/006

(57) ABSTRACT

A problem of providing a laminate which is excellent in transparency, heat resistance, moisture resistance, and abrasion. resistance, has a satisfactory bending workability, and includes a layer containing a methacrylate resin and a styrene-based resin, and a layer containing polycarbonate is solved by the invention of a laminate including: a layer including a resin composition containing 5 mass % or more but less than 50 mass % of a methacrylate resin and 50 mass % or more but less than 95 mass % of a copolymer including at least a structural unit derived from an aromatic vinyl compound represented by the following general formula (a) and a structural unit derived from an acid anhydride represented by the following general formula (b); and a layer including polycarbonate.

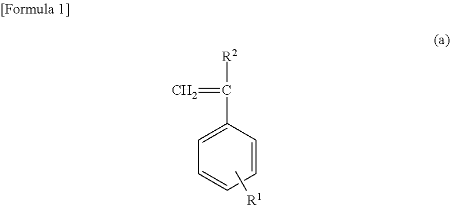

(wherein R¹ and R² are independently represent a hydrogen atom or an alkyl group)

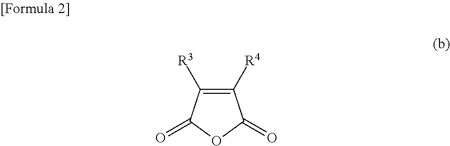

(wherein R³ and R⁴ are independently represent a hydrogen atom or an alkyl group).

### TECHNICAL FIELD

The present invention relates to a laminate. More particularly, the present invention relates to a laminate which is well-balanced in transparency, abrasion resistance, shape stability in hot and humid environments, bending workability, and the like and includes a layer containing polycarbonate and a layer containing a methacrylate resin and a styrene-based resin.

### BACKGROUND ART

A methacrylate resin is excellent in transparency, abrasion resistance, weather resistance, and the like. On the other hand, polycarbonate is excellent in impact resistance and the like. A laminate including a layer containing a methacrylate resin and a layer containing polycarbonate is excellent in transparency, abrasion resistance, weather resistance, impact resistance, and the like, and is used for surface members of, for example, a wall of a house, furniture, automobile components, home electric appliances, electronic devices, and display devices.

In recent years, many such surface members are required to have bending workability in view of design and safety. In the laminate, the polycarbonate has a high heat resistance. Accordingly high-temperature condition is required for bending the laminate. The methacrylate resin having a low heat resistance cannot withstand such condition, which causes problems such as the occurrence of foams and whitening in the laminate. The laminate is often used outdoors or in vehicles in hot and humid conditions. In such conditions the methacrylate having a lower moisture resistance than that of polycarbonate resin, absorbs water and causes a problem that warpage of the laminate occurs.

To solve the above-mentioned problems, an improvement in heat resistance and moisture resistance of a methacrylate resin has been studied. A laminate reported in Patent Literature 1 contains: a methyl methacrylate unit; a unit selected from the group consisting of a methacrylic acid unit, an acrylic acid unit, a maleic anhydride unit, an N-substituted or unsubstituted maleimide unit, a glutaric anhydride structural unit, and a glutarimide structural unit; a layer containing a methacrylate resin which has a glass-transition temperature of 110° C. or higher; and a layer containing polycarbonate. However, the heat resistance and moisture resistance of the methacrylate resin in the laminate are not sufficient enough to solve the above-mentioned problems.

Meanwhile, a copolymer resin composed of styrene and maleic anhydride is known as a resin having a high heat resistance and a high moisture resistance. For example, Non Patent Literature 1 reports a copolymer resin which is composed of styrene and maleic anhydride which contains 18 to 35 mass % of the maleic anhydride, which has a glass-transition temperature in a range from 145 to 175° C. Further, Non Patent Literature 2 discloses a copolymer resin composed of styrene and maleic anhydride with a low water absorbing property. However, in the laminate including a layer containing the resin and a layer containing polycarbonate, the affinity between the resins is low and adhesion properties between the layers are poor. Accordingly, when the laminate is bent, separation between layers is likely to occur, which may result in impairing the appearance of a processed molded product. Moreover the laminate has a low abrasion resistance. There is another problem that rupture, abrasion, or the like occurs when the laminate is used as a surface member.

### CITATION LIST

### Patent Literature

Patent Literature 1: Japanese Unexamined Patent Application Publication No. 2009-248416

### Non Patent Literature

Non Patent Literature 1: XIRAN(R) SMA “New tricks in polymer blends” [Polyscope Polymers BV](http://www.bpri.org/documenten/2008_8_flippo.pdf)

Non Patent Literature 2: THOMASNET NEWS “Polyscope Polymers Expands Scope of XIRAN(R)SMA as Additive for Amorphous Thermoplastics” [2010, Polyscope Polymers BV] (http://news.thomasnet.com/companystory/Polyscope-Polymers-Expands-Scope-of-XIRAN-SMA-as-Additive-for-Amorphous-Thermoplastics-573050)

### SUMMARY OF INVENTION

### Technical Problem

An object of the present invention is to provide a laminate which is excellent in transparency, heat resistance, moisture resistance, and abrasion resistance, has a satisfactory bending workability, and includes a layer containing a methacrylate resin and a styrene-based resin, and a layer containing polycarbonate.

### Solution to Problem

In order to achieve the above-mentioned object, the present invention provides a laminate comprising a layer including a resin composition (hereinafter referred to as a “resin composition (1)”) containing 5 mass % or more but less than 50 mass % of a methacrylate resin and 50 mass % or more but less than 95 mass % of a copolymer (hereinafter referred to as an “SMA resin”) including at least a structural unit derived from an aromatic vinyl compound (hereinafter referred to as an “aromatic vinyl compound (a)”) represented by the following general formula (a) and a structural unit derived from an acid anhydride (hereinafter referred to as “acid anhydride (b)”) represented by the following general formula (b); and a layer including poly carbonate.

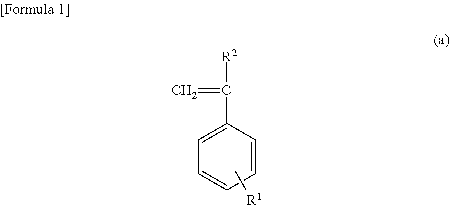

(wherein R¹ and R² are independently represent a hydrogen atom or an alkyl group.)

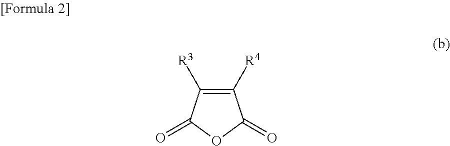

(wherein R³ and R⁴ are independently represent a hydrogen atom or an alkyl group.)

### Advantageous Effects of Invention

A laminate according to the present invention is excellent in transparency, heat resistance, moisture resistance, and abrasion resistance, has a favorable bending workability, and can be suitably used for, for example, automobile components and optical members, while preventing defects in the appearance of a bent molded product, such as warpage, foams, whitening, or peeling.

### BRIEF DESCRIPTION OF DRAWINGS

FIG. 1 is a schematic diagram showing a laminated sheet in a ply adhesion test.

### DESCRIPTION OF EMBODIMENTS

### [Resin Composition (1)]

A resin composition (1) will be described below.

The resin composition (1) contains a methacrylate resin and an SMA resin.

The content of the methacrylate resin in the resin composition (1) is 5 mass % or more but less than 50 mass %, preferably 5 mass % or more but less than 45 mass %, more preferably 10 mass % or more but less than 40 mass %, and still more preferably 15 mass % or more but less than 35 mass %. When the content of the methacrylate resin in the resin composition (1) is 5 mass % or more, the laminate of the present invention is excellent in bending workability, and when the content of the methacrylate resin is less than 50 mass %, the laminate can suppress the occurrence of warpage.

The above-mentioned methacrylate resin is a resin containing structural unit derived from a methacrylate ester.

Examples of the methacrylate ester include: alkyl methacrylates such as methyl methacrylate (hereinafter referred to as “MMA”), ethyl methacrylate, n-propyl methacrylate, isopropyl methacrylate, n-butyl methacrylate, isobutyl methacrylate, tert-butyl methacrylate, pentyl methacrylate, hexyl methacrylate, heptyl methacrylate, 2-ethylhexyl methacrylate, nonyl methacrylate, decyl methacrylate, and dodecyl methacrylate; cycloalkyl methacrylates such as 1-methylcyclopentyl methacrylate, cyclohexyl methacrylate, cycloheptyl methacrylate, cyclooctyl methacrylate, or tricyclo methacrylate [5.2.1.02,6]deca-8-yl; aryl methacrylates such as phenyl methacrylate; and aralkyl methacrylates such as benzyl methacrylate. In terms of availability, MMA, ethyl methacrylate, n-propyl methacrylate, isopropyl methacrylate, n-butyl methacrylate, isobutyl methacrylate, and tert-butyl methacrylate are preferable, and MMA is most preferable. The content of a structural unit derived from the methacrylate ester in the methacrylate resin is preferably 90 mass % or more, more preferably 95 mass % or more, and still more preferably 98 mass % or more. The methacrylate resin may be composed only of the structural unit derived from the methacrylate ester.

Further, in terms of heat resistance, the above-mentioned methacrylate resin preferably contains 90 mass % or more of a structural unit derived from MMA, more preferably 95 mass % or more of the structural unit, and still more preferably 98 mass % or more of the structural unit. The methacrylate resin may be composed only of the structural unit derived from MMA.

The above-mentioned methacrylate resin may contain a structural unit derived from a monomer other than a methacrylate ester. Examples of such a monomer include acrylates such as methyl acrylate (hereinafter referred to as “MA”), ethyl acrylate, n-propyl acrylate, isopropyl acrylate, n-butyl acrylate, isobutyl acrylate, tert-butyl acrylate, hexyl acrylate, 2-ethylhexyl acrylate, nonyl acrylate, decyl acrylate, dodecyl acrylate, stearyl acrylate. 2-hydroxyethyl acrylate, 2-hydroxypropyl acrylate, 4-hydroxybutyl acrylate, cyclohexyl acrylate, 2-methoxyethyl acrylate, 3-methoxybutyl acrylate, trifluoromethyl acrylate, trifluoroethyl acrylate, pentafluoroethyl acrylate, glycidyl acrylate, allyl acrylate, phenyl acrylate, tolyl acrylate, benzyl acrylate, isobornyl acrylate, and 3-dimethylaminoethyl acrylate. In terms of availability, acrylates such as MA, ethyl acrylate, n-propyl acrylate, isopropyl acrylate, n-butyl acrylate, isobutyl acrylate, and tert-butyl acrylate are preferable; MA and ethyl acry late are more preferable; and MA is most preferable. The content of the structural unit derived from these monomers in the methacrylate resin is preferably 10 mass % or less in total, more preferably 5 mass % or less, and still more preferably 2 mass % or less.

The methacrylate resin is obtained by polymerizing the above-mentioned methacrylate ester and another monomer which is an arbitrary component. In the polymerization, when a plurality of species of monomers are used, the plurality of species of monomers are generally mixed to prepare a monomer mixture and are then used for the polymerization. The polymerization method is not particularly limited, but in terms of productivity, it is preferable to perform radical polymerization by, for example, a hulk polymerization method, a suspension polymerization method, a solution polymerization method, or an emulsion polymerization method.

The weight average molecular weight (hereinafter referred to as “Mw”) of the methacrylate resin is preferably 40,000 to 500,000. When the Mw is equal to or more than 40,000, the laminate of the present invention is excellent in abrasion resistance and heat resistance, and when the Mw is equal to or less than 500,000, the resin composition (1) is excellent in molding workability, which leads to an increase in the productivity of the laminate of the present invention.

The term “Mw” described herein indicates a standard polystyrene reduced value which is measured by gel permeation chromatography (GPC).

The content of the SMA resin in the resin composition (1) is 50 mass % or more but less than 95 mass %, preferably 55 mass % or more but less than 95 mass %, more preferably 60 mass % or more but less than 90 mass %, and still more preferably 65 mass % or more but less than 85 mass %. In the laminate of the present invention, when the content of the SMA resin in the resin composition (1) is 50 mass % or more, the occurrence of warpage in hot and humid environments can be suppressed, and when the content is less than 95 mass %, an excellent abrasion resistance is provided.

The above-mentioned SMA resin is a copolymer composed of at least a structural unit derived from an aromatic vinyl compound (a) and a structural unit derived from an acid anhydride (b).

As independent alkyl groups represented by R¹ and R² in the general formula (a) and R³ and R⁴ in the general formula (b), an alkyl group having a carbon number of 12, such as a methyl group, an ethyl group, an n-propyl group, an isopropyl group, an n-butyl group, a sec-butyl group, an isobutyl group, a t-butyl group, an n-pentyl group, an isopentyl group, a neopentyl group, an n-hexyl group, an n-heptyl group, an n-octyl group, a 2-ethylhexyl group, a nonyl group, a decyl group, or a dodecyl group, is preferable, and an alkyl group having a carbon number of 4, such as a methyl group, an ethyl group, an n-propyl group, an isopropyl group, an n-butyl group, a sec-butyl group, an isobutyl group, or a t-butyl group, is more preferable.

A hydrogen atom, a methyl group, an ethyl group, and a t-butyl group are preferably used as R¹. A hydrogen atom, a methyl group, and an ethyl group are preferably used as R², R³, and R⁴.

The content of the structural unit derived from the aromatic vinyl compound (a) in the SMA resin is preferably in a range from 50 to 85 mass %, more preferably in a range from 55 to 82 mass %, and still more preferably in a range from 60 to 80 mass %. When the content is in a range from 50 to 85 mass %, the resin composition (1) is excellent in moisture resistance and transparency.

Examples of the aromatic vinyl compound (a) include styrene; nucleus alkyl-substituted styrenes such as 2-methylstyrene, 3-methylstyrene, 4-methylstyrene, 4-ethylstyrene, and 4-tert-butylstyrene; and α-alkyl-substituted styrene such as α-methylstyrene and 4-methyl-α-methylstyrene. In terms of availability, styrene is preferable. These aromatic vinyl compounds (a) may be used singly or in a combination of two or more species.

The content of the structural unit derived from the acid anhydride (b) in the SMA resin is preferably in a range from 15 to 50 mass %, more preferably in a range from 18 to 45 mass %, and still more preferably in a range from 20 to 40 mass %. When the content is in a range from 15 to 50 mass %, the resin composition (1) is excellent in heat resistance and transparency.

Examples of the acid anhydride (b) include maleic anhydride, citraconic anhydride, and dimethyl maleic anhydride. In view of availability, maleic anhydride is preferable. These acid anhydrides (b) may be used singly or in a combination of two or more species.

The above-mentioned SMA resin preferably contains a structural unit derived from a methacrylate ester monomer, in addition to the aromatic vinyl compound (a) and the acid anhydride (b). The content of the structural unit derived from a methacrylate ester monomer in the SMA resin is preferably in a range from 1 to 35 mass %, more preferably in a range from 3 to 30 mass %, and still more preferably in a range from 5 to 26 mass %. When the content is in a range from 1 to 35 mass %, more excellent bending workability and transparency are obtained.

Examples of the methacrylate ester include MMA, ethyl methacrylate, propyl methacrylate, isopropyl methacrylate, n-butyl methacrylate, propyl methacrylate, isopropyl methacrylate, n-butyl methacrylate, isobutyl methacrylate, t-butyl methacrylate, 2-ethylhexyl methacrylate, cyclohexyl methacrylate, phenyl methacrylate, benzyl methacrylate, and 1-phenylethyl methacrylate. Among these methacrylate esters, alkyl methacrylate having a carbon number of an alkyl group of 1 to 7 is preferable. Since the heat resistance and transparency of the obtained SMA resin are excellent, MMA is particularly preferable. The methacrylate esters may be used singly or in a combination of two or more species.

The above-mentioned SMA resin may include a structural unit derived from a monomer other than the aromatic vinyl compound (a), the acid anhydride (b), and methacrylate ester. Examples of such a monomer include acrylates such as MA, ethyl acrylate, n-propyl acrylate, isopropyl acrylate, n-butyl acrylate, isobutyl acrylate, tert-butyl acrylate, hexyl acrylate, 2-ethylhexyl acrylate, nonyl acrylate, decyl acrylate, dodecyl acrylate, stearyl acrylate, 2-hydroxyethyl acrylate, 2-hydroxypropyl acrylate, 4-hydroxybutyl acrylate, cyclohexyl acrylate, 2-methoxyethyl acrylate, 3-methoxybutyl acrylate, trifluoromethyl acrylate, trifluoroethyl acrylate, pentafluoroethyl acrylate, glycidyl acrylate, allyl acry late, phenyl acry late, tolyl acrylate, benzyl acrylate, isobornyl acrylate, and 3-dimethylaminoethyl acrylate, These monomers may be used singly or in a combination of two or more species. The content of the structural unit derived from these monomers in the SMA resin is preferably 10 mass % or less, more preferably 5 mass % or less, and still more preferably 2 mass % or less.

The above-mentioned SMA resin is obtained by polymerizing the above-mentioned aromatic vinyl compound (a), acid anhydride (h), methacrylate ester, and another monomer which is an arbitrary component. In the polymerization, a monomer mixture is generally prepared by mixing the monomer to be used, and the monomer mixture thus obtained is used for the polymerization. The polymerization method is not particularly limited, but in terms of productivity, it is preferable to perform radical polymerization by, for example, a bulk polymerization method or a solution polymerization method.

The Mw of the SMA resin is preferably in a range from 40,000 to 300,000, When the Mw is 40,000 or more, the laminate of the present invention is excellent in abrasion resistance and impact resistance, and when the Mw is 300,000 or less, the resin composition (1) is excellent in molding workability, and thus the productivity of the laminate of the present invention can be increased.

In terms of suppression of occurrence of warpage of the laminate in hot and humid environments, transparency, abrasion resistance, and flex crack resistance, a mass ratio (methacrylate resin/SMA resin) between methacrylate resin and SMA resin contained in the resin composition (1) is preferably in a range from 50/50 to 5/95, more preferably in a range from 45/55 to 5/95, still more preferably in a range from 40/60 to 10/90, and most preferably in a range from 35/65 to 15/85.

The resin composition (1) is obtained by mixing the above-mentioned methacrylate resin and SMA resin. In the mixing process, a melt mixing method or a solution mixing method, and the like can be used. In the melt mixing method, melt kneading is carried out under an atmosphere of an inert gas, such as a nitrogen gas, an argon gas, or a helium gas, as needed, by a melt kneader, such as a uniaxial or multi-axial kneader, an open roll, a Banbury mixer, or a kneader. In the solution mixing method, the methacrylate resin and the SMA resin are mixed by dissolving them in an organic solvent, such as toluene, tetrahydrofuran, or methyl ethyl ketone.

The resin composition (1) may contain a polymer other than the methacrylate resin and SMA resin as long as the advantages effects of the present invention are not impaired. Examples of such a polymer include polyolefin such as polyethylene or polypropylene, thermoplastic resin such as polyamide, polyphenylene sulfide, polyetheretherketone, polyester, polysulfone, polyphenyleneoxide, polyimide, polyetherimide, or polyacetal; and thermosetting resin such as phenolic resin, melamine resin, silicone resin, or epoxy resin. These polymers may be used singly or in a combination of two or more species.

The content of these polymers in the resin composition (1) is preferably 10 mass % or less, more preferably 5 mass % or less, and still more preferably 2 mass %.

The resin composition (1) may contain various additives as needed. Examples of the additives include an antioxidant, a heat-deterioration inhibitor, an ultraviolet absorbing agent, a light stabilizer, a lubricant, a mold releasing agent, a polymer processing assistant, an antistatic additive, a fire retardant, a dye/pigment, a light diffuser, a flatting agent, an impact resistance modifying agent, and a fluorescent material. The content of these additives can be arbitrarily set as long as the advantages effects of the present invention are not impaired. For example, for 100 parts by weight of the resin composition (1), the content of an antioxidant is 0.01 to 1 parts by weight; the content of an ultraviolet absorbing agent is preferably 0.01 to 3 parts by weight; the content of a light stabilizer is preferably 0.01 to 3 parts by weight; the content of a lubricant is preferably 0.01 to 3 parts by weight; and the content of a dye/pigment is preferably 0.01 to 3 parts by weight.

When another polymer and/or an additive is contained in the resin composition (1), another polymer and/or an additive may be added during polymerization of the methacrylate resin and/or the SMA resin, may be added during mixing of the methacrylate resin and the SMA resin, or may be added after mixing of the methacrylate resin and the SMA resin.

The glass-transition temperature of the resin composition (1) is preferably in a range from 120 to 160° C., more preferably in a range from 130 to 155° C., and still more preferably in a range from 140 to 150° C. When the glass-transition temperature is in a range from 120 to 160° C., the occurrence of warpage of the laminate obtained by the present invention in hot and humid environments can be suppressed.

Note that the glass-transition temperature described herein refers to a temperature which is calculated by a midpoint method after measuring the temperature at a rate of temperature rise of rate of 10° C./minutes by a differential scanning calorimeter.

The melt flow rate (hereinafter referred to as “MFR”) of the resin composition (1) is preferably in a range from 1 to 10 g/10 minutes, more preferably in a range from 1.5 to 7 g/10 minutes, and still more preferably in a range from 2 to 4 g/10 minutes. When the MFR is in a range from 1 to 10 g/10 minutes, the stability of heat melt molding is excellent.

Note that the term “MFR” of the resin composition (1) described herein indicates a value which is measured under conditions of a temperature of 230° C. and a load of 3.8 kg by using a melt indexer.

### [Polycarbonate]

Polycarbonate used for the laminate of the present invention is favorably obtained by copolymerizing dihydric phenol and a carbonate precursor.

Examples of the above-mentioned dihydric phenol include 2,2-bis(4-hydroxyphenyl)propane (commonly known as bisphenol A), 1,1-bis(4-hydroxyphenyl)ethane, 1,1-bis(4-hydroxyphenyl)cyclohexane, 2,2-bis(3-methyl-4-hydroxyphenyl)propane, 2,2-bis(3,5-dimethyl-4-hydroxyphenyl)propane, bis(4-hydroxyphenyl) sulfide, and bis(4-hydroxyphenyl) sulfone. Among them, bisphenol A is preferable. These dihydric phenols may be used singly or in a combination of two or more species.

Examples of the above-mentioned carbonate precursor include a carbonyl halide such as phosgene; a carbonate ester such as diphenyl carbonate; and haloformate such as dihaloformate of dihydric phenol. These carbonate precursors may be used singly or in a combination of two or more species.

The method for manufacturing the polycarbonate is not particularly limited. Examples of the method include: an interfacial polymerization method that allows an aqueous solution of dihydric phenol to react with an organic solvent solution of carbonate precursor at an interface; and an ester exchange method that allows a dihydric phenol to react with a carbonate precursor under conditions of a high temperature, reduced pressure, and no solvent.

The Mw of the polycarbonate is preferably in a range from 10,000 to 100,000, and more preferably in a range from 20,000 to 70,000. When the Mw is 10,000 or more, the laminate of the present invention is excellent in impact resistance and heat resistance, and when the Mw is 100,000 or less, the polycarbonate is excellent in molding workability, which leads to an increase in the productivity of the laminate of the present invention.

The above-mentioned polycarbonate may contain other polymers as long as the advantages effects of the present invention are not impaired. As the other polymers, methacrylate resin, the resin composition (1), and other polymers similar to the polymers which may be contained in the resin composition (1) can be used. The other polymers may be used singly or in a combination of two or more species.

The content of the other polymers in the polycarbonate is preferably 15 mass % or less, more preferably 10 mass % or less, and still more preferably 5 mass % or less.

The above-mentioned polycarbonate may contain various additives as needed. As the additives, additives similar to the additives which may be contained in the resin composition (1) can be used. The content of these additives can be arbitrarily set as long as the advantageous effects of the present invention are not impaired. For 100 parts by weight of the polycarbonate, the content of an antioxidant is preferably 0.01 to 1 parts by weight; the content of an ultraviolet absorbing agent is preferably 0.01 to 3 parts by weight; the content of a light stabilizer is preferably 0.01 to 3 parts by weight; the content of a lubricant is preferably 0.01 to 3 parts by weight; and the content of a dye/pigment is preferably 0.01 to 3 parts by weight.

When another polymer and/or an additive is contained in the polycarbonate, another polymer and/or an additive may be added during copolymerization of dihydric phenol and carbonate precursor, or may be added and melt-kneaded after completion of the copolymerization.

The glass-transition temperature of the polycarbonate is preferably in a range from 120 to 160° C., more preferably in a range from 135 to 155° C., and still more preferably in a range from 140 to 150° C. When the glass-transition temperature is in a range from 120 to 160° C., the occurrence of warpage of the laminate of the present invention in hot and humid environments can be suppressed.

The MFR of the polycarbonate is preferably in a range from 1 to 0 minutes, more preferably in a range from 3 to 20 g/10 minutes, and still more preferably in a range from 5 to 10 g/10 minutes. When the MFR is in a range from 1 to 30 g/10 minutes, the stability of heat melt molding is excellent.

The MFR of the polycarbonate described herein is measured under conditions of a temperature of 300° C. and a load of 1.2 kg by using the melt indexer.

Commercial items may be used as the above-mentioned polycarbonate. For example, “CALIBRE®” and “SD POLYCA®” manufactured by Sumika Styron Polycarbonate Limited; “Lupilon/Novarex®” manufactured by Mitsubishi Engineering-Plastics Corporation; “TARFLON®” manufactured by Idemitsu Kosan Co., Ltd.; and “Panlite®” manufactured by TEIJIN LIMITED can be favorably used.

### [Laminate]

The laminate of the present invention may include a plurality of layers formed of the resin composition (1) and/or a plurality of layers formed of polycarbonate.

The laminate of the present invention may include a layer composed of another resin (another resin layer), as well as the layer composed of the resin composition (1) and the layer composed of polycarbonate. Examples of the resin included in another resin layer include various thermoplastic resins other than the resin composition. (1) and polycarbonate; thermoset resins; and energy ray-curable resins.

Examples of another resin layer described above include an abrasion-resistant layer, an antistatic layer, an antifouling layer, a friction-reducing layer, an anti-glare layer, an anti-reflection layer, an adhesive layer, and an impact stress applying layer.

These resin layers may be used singly or in a combination of two or more. When a plurality of these resin layers are formed, they may be formed of the same type of resin, or different types of resin. In the laminate of the present invention, the order of arrangement of these resin layers is not particularly limited. These resin layers may be formed on a surface or within a layer.

In view of production with high productivity while maintaining an excellent appearance, the thickness of the laminate of the present invention is preferably in a range from 0.03 to 5.0 mm, more preferably in a range from 0.05 to 4.0 mm, and more preferably in a range from 0.1 to 3.0 mm.

The thickness of the layer composed of the resin composition (1) in the laminate of the present invention is preferably in a range from 0.01 to 0.5 mm, more preferably in a range from 0.015 to 0.3 mm, and still more preferably in a range from 0.02 to 0.1 mm. When the thickness is less than 0.01 mm, the abrasion resistance and weather resistance may be insufficient. When the thickness exceeds 0.5 mm, the impact resistance may be insufficient.

The thickness of the layer composed of polycarbonate in the laminate of the present invention is preferably in a range from 0.02 to 4.9 mm, more preferably in a range from 0.035 to 3.9 mm, and still more preferably in a range from 0.08 to 2.9 mm. When the thickness is less than 0.02 mm, the impact resistance may be insufficient. When the thickness exceeds 4.9 mm, the productivity may be lowered.

When the laminate of the present invention includes only the layer(s) composed of the resin composition (1) and the layer(s) composed of polycarbonate, assuming that the layer composed of the resin composition (1) is represented by (1) and the layer composed of polycarbonate is represented by (2), the layers of the laminate of the present invention may be laminated in the order of, for example, (1)-(2); (1)-(2)-(1); (2)-(1)-(2); or (1)-(2)-(1)-(2)-(1). For increasing the abrasion resistance, it is preferable to laminate the layers in the order of, for example, (1)-(2); (1)-(2)-(1); or (1)-(2)-(1)-(2)-(1) so that at least one surface is formed of the layer composed of the resin composition (1).

When the laminate of the present invention includes another resin layer, assuming that another resin layer is represented by (3), the layers of the laminate of the present invention may be laminated in the order of, for example, (1)-(2)-(3); (3)-(1)-(2); (3)-(1)-(2)-(3); (3)-(1)-(2)-(1)-(3); or (1)-(2)-(3)-(2)-(1). For example, when the layer (3) is an abrasion-resistant layer, assuming that the abrasion-resistant layer is represented by (3′), the layers of the laminate of the present invention are preferably laminated in the order of, for example, (3′)-(1)-(2), (3′)-(1)-(2)-(3′), or (3′)-(1)-(2)-(1)-(3′) so that at least one surface is formed of the abrasion-resistant layer.

When the laminate of the present invention includes another resin layer different from the layer (3), as well as the layer (3), assuming that the resin layer different from the layer (3) is represented by (4), the layers of the laminate of the present invention may be laminated in the order of, for example, (1)-(2)-(3)-(4); (4)-(3)-(1)-(2(4)-(3)-(1)-(2)-(3); (4)-(1)-(2)- (3); (4)-(3)-(1)-(2)-(3)-(4); or (4)-(3)-(1)-(2)-(1)-(3)-(4).

For example, when the layer (3) is an abrasion-resistant layer and the layer (4) is an anti-reflection layer, assuming that the anti-reflection layer is represented by (4′), the layers of the laminate are preferably laminated in the order of, for example, (4′)-(3′)-(1)-(2); (4′)-(3′)-(1)-(2)-(3′); (4′)-(3′)-(1)-(2)-(3′)-(4′); or (4′)-(3′)-(1)-(2)-(1)-(3′)-(4′),

In order to suppress the occurrence of warpage of the laminate in hot and humid environments, the layers of the laminate of the present invention are preferably laminated in the order in which the layers are symmetrical with respect to the thickness direction, and are more preferably the thicknesses of the layers are symmetrical to each other.

The method for manufacturing the laminate of the present invention is not particularly limited. However, in general, the layer composed of the resin composition (1) and the layer composed of polycarbonate are preferably laminated by multilayer molding. Examples of multilayer molding include lamination molding methods such as multilayer extrusion molding, multilayer blow molding, multilayer press molding, multi-color injection molding, and insert injection molding. In terms of productivity, multilayer extrusion molding is preferable.

Examples of the method for laminating another resin layer include a method of performing multilayer molding of another resin layer together with the layer composed of the resin composition (1) and the layer composed of polycarbonate in the manner as described above; a method of coating the surface of one of the layer composed of the resin composition (1) and the layer composed of polycarbonate, which are prepared in advance, with another fluid resin, and drying or curing the resin; and a method of laminating another resin layer on one of the layer composed of the resin composition (1) and the surface of polycarbonate, which are prepared in advance, via an adhesive layer,

The method of multilayer extrusion molding is not particularly limited. Known multilayer extrusion molding methods for use in manufacturing a multilayer laminate of thermoplastic resin can be preferably employed. More favorably, molding using a device including a flat T-die and a polling roll with a mirror-finished surface is employed.

In this case, as a T-die system, a feed block system for laminating the resin composition (1) in a heated molten state and polycarbonate before being fed into the T-die, a multi-manifold system for laminating the resin composition (1) and polycarbonate within the T-die, and the like can be employed. For increasing the smoothness of an interface between layers constituting the laminate, the multi-manifold system is preferable.

In this case, examples of the polling roll include a metal roll and an elastic roll having a metallic thin film formed on an outer periphery thereof (which may be referred to as a metal elastic roll). The metal roll is not particularly limited as long as it has high rigidity. Examples of the metal roll include a drilled roll and a spiral roll. The surface state of the metal roll is not particularly limited, and may be, for example, a mirror surface, or may have patterns or a concave-convex shape. The metal elastic roll is composed of, for example, a substantially columnar shaft roll rotatably provided, a metallic thin film disposed so as to cover the outer peripheral surface of the shaft roll and has a cylindrical shape in contact with a film-like object, and a fluid encapsulated between the shaft roll and the metallic thin film. Since the metal elastic roll includes the fluid, the metal elastic roll shows elasticity. The shaft roll is not particularly limited and is formed of, for example, stainless steel. The metallic thin film is formed of, for example, stainless steel, and the thickness of the metallic thin film is preferably about 2 to 5 mm. The metallic thin film preferably has bendability, flexibility, and the like, and preferably has a seamless structure with no welded seam. The metal elastic roll including such a metallic thin film is excellent in durability and can be treated like a general mirror-finished roll if the metallic thin film is mirror-finished. Further, the metal elastic roll is convenient because the shape of the metal elastic roll can be transferred to the metallic thin film when the pattern or concave-convex shape of the metal elastic roll is applied to the metallic thin film.

The resin composition (1) and polycarbonate are preferably melt-filtered by a filter before multilayer molding and/or during multilayer molding. Multilayer molding using the melt-filtered resin compositions makes it possible to obtain a laminate with less defects due to a foreign matter or gel. The filter material of the filter to be used is not particularly limited, and is appropriately selected depending on the use temperature, viscosity, and filtration accuracy. For example, a non-woven fabric, such as polypropylene, cotton, polyester, rayon, or glass fiber; a phenolic resin-impregnated cellulose film; a metal fiber non-woven fabric sintered film; a metal powder sintered film; a woven metal wire; or a combination thereof can be used. Especially, in terms of heat resistance and durability, it is preferable to use a plurality of laminated metal fiber non-woven fabric sintered films.

The filtration accuracy of the filter is not particularly limited, but is preferably 30 μm or less, more preferably 10 μm or less, and still more preferably 5 μm or less.

An abrasion-resistant layer will be described in detail below as an example of the layer composed of another resin composition. The abrasion-resistant layer used herein is a layer for increasing a hardness measured by a pencil scratch test. It is preferable that the abrasion-resistant layer be a layer showing a hardness of “3H” or more in the pencil scratch test specified in JIS-K5600-5-4. The abrasion-resistant layer is preferably formed on the surface of the layer composed of the resin composition (1).

The thickness of the abrasion-resistant layer is preferably in a range from 2 to 10 μm, more preferably in a range from 3 to 8 μm, and still more preferably in a range from 4 to 7 μm. When the thickness is 2 μm or more, there is a tendency that the abrasion resistance can be maintained, and when the thickness is 10 μm or less, there is a tendency that the laminate has an excellent impact resistance.

The abrasion-resistant layer is generally formed by coating the surface of another layer (for example, the layer composed of the resin composition (1) or the layer composed of polycarbonate) with a fluid curable composition, such as a monomer, oligomer, or resin, and by curing the composition. Examples of such curable compositions include a thermosetting composition which is curable by heat, and an energy ray-curable composition which is curable by an energy ray, such as an electron beam, radiation, or ultraviolet light.

Examples of the thermosetting composition include compositions containing phenolic resin, urea resin, diallyl phthalate resin, melamine resin, guanamine resin, unsaturated polyester resin, polyurethane resin, epoxy resin, amino alkyd resin, melamine-urea co-condensation resin, silicon resin, or polysiloxane resin.

These thermosetting compositions may contain, for example, a crosslinking agent, a curing agent such as a polymerization initiator, or a polymerization accelerator, as needed. In general, as the curing agent, isocyanate, organic sulfonic acid, or the like is used for polyester resin and polyurethane resin; amine is used for epoxy resin; a peroxide, such as methyl ethyl ketone peroxide, and a radical initiator, such as azobisisobutyl ester, are used for unsaturated polyester resin.

Examples of the energy ray-curable composition include compositions containing an oligomer and/or a monomer having a polymerization unsaturated bond, such as an acryloyl group or a methacryloyl group, a thiol group, or an epoxy group in a molecule. For increasing the abrasion resistance, a composition containing an oligomer and/or a monomer having a plurality of acryloyl groups or methacryloyl groups is preferable.

The energy ray-curable composition may contain a photopolymerization initiator and/or a photosensitizer. Examples of the photopolymerization initiator include a carbonyl compound such as benzoin methyl ether, acetophenone, 3-methylacetophenone, benzophenon, or 4-chlorobenzophenon; a sulfur compound such as tetramethylthiuram monosulfide or tetramethylthiuram disulfide; 2,4,6-trimethylbenzoyldiphenylphosphine oxide, and benzoyldiethoxyphosphine oxide. Examples of the photosensitizer include n-butylamine, triethylamine, and tri-n-butylphosphine.

In the curable composition, the content of these curable compounds is preferably in a range from 30 to 100 mass %, more preferably in a range from 40 to 95 mass %, and still more preferably in a range from 50 to 95 mass %. These curable compounds may be used singly or in a combination of two or more species.

The curable composition may contain, as needed, an additive such as a monofunctional monomer, an organic solvent, a leveling agent, an antiblocking agent, a dispersion stabilizer, an ultraviolet absorbing agent, a light stabilizer, an antioxidant, an anti-foam agent, a thickener, a lubricant, an antistatic additive, a stain-proofing agent, an anti-fog additive, a filler, or a catalyst. The content of these additives can be appropriately set as long as the advantages effects of the present invention are not impaired.

Examples of the method for coating the curable composition include a spin coating method, a dip method, a spray method, a slide coating method, a bar coating method, a roll coating method, a gravure coating method, a meniscus coating method, a flexographic printing method, and a screen printing method.

### EXAMPLES

The present invention will be described in more detail below with reference to examples and the like, but the present invention is not limited to these examples.

Resin compositions obtained in Production Examples described below, laminates obtained in Examples and Comparative Examples, and sheets obtained in Reference Examples were evaluated by the following method.

### [Glass-Transition Temperature]

A sheet obtained in Reference Example was dried for 24 hours under reduced pressure (1 kPa) at 80° C. After that, a test piece of 10 mg was cut out and sealed in an aluminum pan, and nitrogen substitution was carried out for more than 30 minutes by using a differential scanning calorimeter (“DSC-50” manufactured by Rigaku Corporation). Then, in a nitrogen air flow of 10 ml/minute, the temperature of the test piece was temporarily increased at a rate of 20° C./minute from 25° C. to 200° C. and held for 10 minutes, and was then cooled to 25° C. (primary scanning). Next, the temperature of the test piece was increased to 200° C. at a rate of 10° C./minute (secondary scanning), and the glass-transition temperature was calculated by a midpoint method.

### [Water Absorption at Saturation]

A test piece prepared by cutting out of a sheet obtained in Reference Example a square piece with a side of 50 mm was dried for 24 hours under reduced pressure (1 kPa) at 80° C. and then cooled in a desiccator at a temperature of 23° C. and a relative humidity of 50%. After that, the mass of the test piece was measured and used as an initial mass. Next, the test piece was soaked in distilled water of 23° C. and the mass was measured with time. A water absorption at saturation was calculated by the following formula using the mass (mass of water absorption) at the time when no mass change was observed, water absorption at saturation (%)=[(mass of water absorption−initial mass)/initial mass]×100

### [Total Light Transmittance]

Laminates obtained in Examples and Comparative Examples and sheets obtained in Reference Examples were each measured in accordance with the method specified in HS-1(7361 by using a spectrocolorimeter SE5000 manufactured by NIPPON DENSHOKU INDUSTRIES CO., LTD.

### [Warpage Variation]

Test pieces each having a short side of 65 mm and a long side of 110 mm were prepared by cutting out of each of the laminates of Examples and Comparative Examples rectangular pieces having short sides along a direction parallel to the direction of the extrusion flow and long sides along a direction perpendicular to the direction of the extrusion flow. After that, the test pieces were left for 24 hours under an environment of a temperature of 23° C. and a relative humidity of 50%.

In this case, an arcuate warpage occurred in each of the test pieces according to Examples 1 to 4 and Comparative Examples 1 and 3 along the long sides thereof in such a manner that the layer composed of the resin composition (1) (or the layer composed of the resin composition (1′) or an SMA resin (A) which was used instead of the resin composition (1)) was located inside and the layer composed of polycarbonater was located outside. On the other hand, an arcuate warpage occurred in the test piece of Comparative Example 2 along the long sides thereof in such a manner that the layer composed of methacrylate resin was located outside and the layer composed of polycarbonate was located inside (that is, the test piece was warped in a direction opposite to that of the other Examples 1 to 4 and Comparative Examples 1 and 3).

Each of the test pieces in which the arcuate warpage occurred was placed on a platen in such a manner that a central portion of each test piece was in contact with the platen (i.e., each test piece was placed so as to be convex downward). Then, a maximum value of a gap between each test piece and the platen was measured by a feeler, and this value was set as an initial amount of warpage.

Next, a short side of each test piece was clipped on to an environment test machine, which was set to a temperature of 85° C. and a relative humidity of 85%, so that the test piece was hung in the machine, and was left for 72 hours in that state. After that, each test piece was cooled for four hours under an environment of 3° C. As a result, an arcuate warpage occurred in all the test pieces of Examples 1 to 4 and Comparative Examples 1 to 3 along the long side thereof in such a manner that the layer composed of the resin composition (1) (or the layer composed of the resin composition (1′), methacrylate resin, or the SMA resin (A) which was used instead of the resin composition (1)) was located inside and the layer composed of polycarbonate was located outside. The maximum value of the gap between each test piece and the platen was measured in a similar manner, and the obtained value was set as the warpage amount under an environment of high temperature and humidity.

A difference between the initial amount of warpage and the warpage amount under an environment of high temperature and humidity [(warpage amount under an environment of high temperature and humidity)−(initial amount of warpage)] was evaluated as a warpage variation.

### [Pencil Scratch Hardness]

The hardness was measured by a table movement type pencil scratch test machine (model P) (manufactured by TOYO SEIKI Co., Ltd.). The core of a pencil was pressed against the surface of the layer composed of the resin composition (1) (or the layer composed of the resin composition (1′), methacrylate resin, or the SMA resin (A) which was used instead of the resin composition (1)) of each of the laminates obtained in Examples and Comparative Examples at an angle of 45 degrees and a load of 750 g, and the presence or absence of a scar due to a scratch was checked. The hardness of the core of the pencil was gradually increased and the hardness of the core that is one level lower than that used when the scar was generated was used as a pencil scratch hardness.

### [Interlayer Adhesion]

A single-layer strip-shaped sheet (corresponding to a first layer of each of Examples and Comparative Examples) having a width of 25 mm, a length of 100 mm, and a thickness of 1 mm was prepared in such a manner that the resin compositions obtained in Production Examples 1 to 5, the methacrylate resin, the SMA resin (A), and an SMA resin (B) which were used in Examples were each placed in a mold frame and pressed for five minutes at 230° C. and 50 kg/cm². Further, a single layer sheet having the same dimensions was prepared under the same conditions as those described above by using the polycarbonate used in Examples (corresponding to a second layer of each of Examples and Comparative Examples). One side of each of the obtained single-layer sheets was reinforced with an aluminum board.

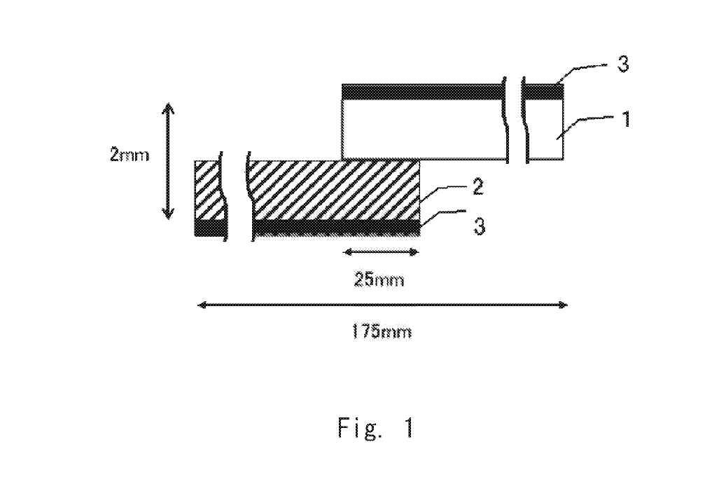

One of single-layer sheets corresponding to the first layer of each of Examples and Comparative Examples was selected and the single-layer sheets and the single-layer sheet composed of polycarbonate were placed in a mold frame so that the both single-layer sheets were in close contact on the side opposite to the aluminum board in such a manner that the width of the portion overlapping the single-layer sheet composed of polycarbonate was 25 mm and the length thereof was 25 mm. Then, the single-layer sheets were pressed for five minutes at 230° C. and 100 kg/cm². Thus, a two-layer laminated sheet having a width of 25 mm, a length of 175 mm, and a thickness at the overlapping portion of 2 mm was obtained (see FIG. 1), By the method described above, laminated sheets having the same two-layer structure as Examples and Comparative Examples were prepared. The obtained laminated sheets were measured in accordance with the method specified in JIS-K6850. Specifically, a tensile shear strength test was conducted on the adhesive surface between the layer (corresponding to the first layer of Examples and Comparative Examples) composed of the resin composition (or methacrylate resin or SMA resin) and the layer (corresponding to the second layer of Examples and Comparative Examples) composed of polycarbonate at a stress rate of 50 mm/min by Autograph AG-1S (manufactured by Shimadzu Corporation) and was evaluated by a visual check. The test was carried out under an environment of a temperature of 23° C. and a relative humidity of 50% by using the laminated sheets subjected to moisture conditioning for 24 hours under an environment of a temperature of 23° C. and a relative humidity of 50%.

### [Evaluation Criteria]

∘: A cohesive failure at an interface
Δ: A partial cohesive failure at an interface
x: boundary separation

It seems that when two adjacent layers of resin are laminated by thermal fusion, the interlayer adhesion depends on the resin. The relative merits of interlayer adhesion affect the relative merits of the bending workability of the laminate.

### [Bending Workability]

Test pieces each having a short side of 50 mm and a long side of 200 mm were prepared by cutting out of the laminates obtained in Examples and Comparative Examples rectangular pieces each having short side in a direction parallel to the extrusion flow direction and a long side in a direction perpendicular to the extrusion flow direction. The test pieces were uniformly heated from above and below in the thickness direction by a far-infrared heater. After the temperatures of the front and back sides of the principle surface of each test piece reached 160° C., the test pieces were bent using a mold with a curvature radius of 25 mm in such a manner that the polycarbonate layer of the laminate was located inside. The processing status of each test piece was evaluated by a visual check.

### [Evaluation Criteria]

∘: Nothing abnormal in appearance
Δ: A negligible amount of removal, foaming, or fluctuation occurred
x: Any one of removal, foaming, and fluctuation occurred

In Production Examples, the methacrylate resin and the SMA resin as listed below were used.

### [Methacrylate Resin]

A methacrylate resin manufactured by KURARAY CO., LTD., Product Name: Parapet HR-S (copolymer with a mass composition ratio between MMA and MA of 98.9:1.1, Mw=90,000)), was used.

### [SMA Resin]

Each SMA resin can be obtained by the following method. The SMA resin (A) which is a styrene-maleic anhydride-MMA copolymer can be obtained by the method specified in WO 2010/013557. As the SMA resin (B), product name: XIRAN26080 manufactured by POLYSCOPE can be used.

Table 1 shows the mass composition ratio and weight average molecular weight (Mw) of the SMA resin (A) and SMA resin (B) used herein.

### [Mass Composition Ratio]

The copolymer composition of each of the SMA resin (A) and the SMA resin (B) was obtained by a 13C-NMR method according to the following procedure.

As a 13C-NMR spectrum, a nuclear magnetic resonance apparatus (GX-270 manufactured by JEOL Ltd.) was used. A sample solution was adjusted by dissolving 1.5 g of the SMA resin (A) or SMA resin (B) in 1.5 ml of deuterated chloroform, and measurements were made under an environment of room temperature and under a condition in which the number of integrations was 4000 to 5000. Based on the measurement results, the following values were obtained.
[the integrated intensity of a carbon peak (in the vicinity of 127, 134, and 143 ppm) of a benzene ring (carbon number 6) in a styrene unit]/6
[the integrated intensity of a carbon peak (in the vicinity of 170 ppm) of a carbonyl site (carbon number 2) in a maleic anhydride unit]/2
[the integrated intensity of a carbon peak (in the vicinity of 175 ppm) of a carbonyl site (carbon number 1) in an MMA unit]/1

Based on the area ratio of the above-mentioned values, the molar ratio of styrene units, maleic anhydride units, and MMA units in each sample was obtained. Based on the obtained molar ratio and the mass ratio (styrene units : maleic anhydride units : MMA=104:98:100) of each monomer unit, the composition of each monomer in the SMA resin (A) and SMA resin (B) was obtained.

### [Weight Average Molecular Weight (Mw)]

The Mw of each of the SMA resin (A) and the SMA resin (B) was obtained by a GPC method according to the following procedure.

Tetrahydrofuran was used as an eluting solvent, and two lines of TSKgel SuperMultipore HZM-M manufactured by TOSOH CORPORATION that are connected in series with SuperHZ4000 were used as a column. As a GPC device, FILC-8320 (product number) manufactured by TOSOH CORPORATION including a refractive index detector (RI detector) was used. The sample solution was adjusted by dissolving 4 mg of the SMA resin (A) or SMA resin (B) in 5 ml of tetrahydrofuran. The temperature of the column oven was set to 40° C. and 20 μl of the sample solution was injected at an eluting solvent flow rate of 0.35 ml/minute, and then the chromatogram was measured. A calibration curve representing the relationship between the holding time and the number of molecules was created by measuring 10 points of standard polystyrene, the number of molecules of which was within a range from 400 to 5000000, by GPC. The Mw was determined based on this calibration curve.

TABLE 1

| | Resin composition (mass %) | | | |
|---|---|---|---|---|
| | | Maleic | | |
| | Styrene | anhydride | MMA | Mw |
| SMA resin (A) | 56 | 18 | 26 | 150000 |
| SMA resin (B) | 74 | 26 | 0 | 80000 |

### Production Example 1

95 parts by weight of the SMA resin (A) and 5 parts by weight of methacrylate resin were supplied to a hopper of a biaxial extruder and were subjected to extrusion molding by melt-kneading at a cylinder temperature of 230° C., thereby obtaining a pellet-like resin composition (hereinafter referred to as a “resin composition (1-1)”). Table 2 shows the composition. Note that the MFR of the resin composition (1-1) measured by the melt indexer at a temperature of 230° C. and a load of 3.8 kg was 1.9 g/10 minutes.

### Production Example 2

90 parts by weight of the SMA resin (A) and 10 parts by weight of the methacrylate resin were supplied to the hopper of the biaxial extruder and were subjected to extrusion molding by melt-kneading at a cylinder temperature of 230° C., thereby obtaining a pellet-like resin composition (hereinafter referred to as a “resin composition (1-1)”). Table 2 shows the composition. Note that the MFR of the resin composition (1-2) measured by the melt indexer at a temperature of 230° C. and a load of 3.8 kg was 1.9 g/10 minutes.

### Production Example 3

70 parts by weight of the SMA resin (A) and 30 parts by weight of the methacrylate resin were supplied to the hopper of the biaxial extruder and were subjected to extrusion molding by melt-kneading at a cylinder temperature of 230° C., thereby obtaining a pellet-like resin composition (hereinafter referred to as a “resin composition (1-3)”). Table 2 show the composition. Note that the MFR of the resin composition (1-3) measured by the melt indexer at a temperature of 230° C. and a load of 3.8 kg was 2.0 g/10 minutes.

### Production Example 4

70 parts by weight of the SMA resin (B) and 30 parts by weight of the methacrylate resin were supplied to the hopper of the biaxial extruder and were subjected to extrusion molding by melt-kneading at a cylinder temperature of 230° C., thereby obtaining a pellet-like resin composition (hereinafter referred to as a “resin composition (1-4)”). Table 2 show the composition. Note that the MFR of the resin composition (1-4) measured by the melt indexer at a temperature of 230° C. and a load of 3.8 kg was 3.8 g/10 minutes.

### Production Example 5

60 parts by weight of the SMA resin (A) and 40 parts by weight of the methacrylate resin were supplied to the hopper of the biaxial extruder and were subjected to extrusion molding by melt-kneading at a cylinder temperature of 230° C., thereby obtaining a pellet-like resin composition (hereinafter referred to as a “resin composition (1-5)”). Table 2 show the composition. Note that the MFR of the resin composition (1-5) measured by the melt indexer at a temperature of 230° C. and a load of 3.8 kg was 2.0 g/10 minutes.

### Production Example 6

51 parts by weight of the SMA resin (A) and 49 parts by weight of the methacrylate resin were supplied to the hopper of the biaxial extruder and were subjected to extrusion molding by melt-kneading at a cylinder temperature of 230° C., thereby obtaining a pellet-like resin composition (hereinafter referred to as a “resin composition (1-6)”). Table 2 show the composition. Note that the MFR of the resin composition (1-6) measured by the melt indexer at a temperature of 230° C. and a load of 3.8 kg was 2.1 g/10 minutes.

### Production Example 7

30 parts by weight of the SMA resin (A) and 70 parts by weight the methacrylate resin were supplied to the hopper of the biaxial extruder and were subjected to extrusion molding by melt-kneading at a cylinder temperature of 230° C., thereby obtaining a pellet-like resin composition (hereinafter referred to as a “resin composition (1′)”). Table 2 shows the composition. Note that the MFR of the resin composition (1′) measured by the melt indexer at a temperature of 230° C. and a load of 3.8 kg was 2.3 g/10 minutes.

TABLE 2

| | | Methacrylate | SMA resin | |
|---|---|---|---|---|
| | | resin | (A) | (B) |
| Production | Resin Composition (1-1) | 5 | 95 | |
| Example 1 | | | | |
| Production | Resin Composition (1-2) | 10 | 90 | |
| Example 2 | | | | |
| Production | Resin Composition (1-3) | 30 | 70 | |
| Example 3 | | | | |
| Production | Resin Composition (1-4) | 30 | | 70 |
| Example 4 | | | | |
| Production | Resin Composition (1-5) | 40 | 60 | |
| Example 5 | | | | |
| Production | Resin Composition (1-6) | 49 | 51 | |
| Example 6 | | | | |
| Production | Resin Composition (1′) | 70 | 30 | |
| Example 7 | | | | |

### Example 1

Pellets of polycarbonate (“Calibre 300-8” manufactured by Sumika Styron Polycarbonate Limited, Mw=50,000, glass-transition temperature=150° C., and MFR at a temperature of 300° C. and a load of 1.2=6.7 g/10 minutes) were sequentially loaded into a single-axis extruder with an axis diameter of 50 mm, and were extruded in a molten state under conditions of a cylinder temperature of 280° C. and a discharge amount of 30 kg/hour. On the other hand, pellets of the resin composition (1-1) were sequentially loaded into a single-axis extruder with an axis diameter of 30 mm, and were extruded in a molten state under conditions of a cylinder temperature of 220° C. and a discharge amount of 2 kg/hour. The polycarbonate and the resin composition (1-1) in the molten state were introduced into a junction block and were laminated by a multi-manifold die set at 250° C. and subjected to extrusion molding into a sheet-like form. Thus, a laminate having a thickness of 1000 μm and including two layers, i.e., the layer (first layer) composed of the resin composition (1-1) with a thickness of 60 μm and the layer (second layer) composed of polycarbonate with a thickness of 940 μm was manufactured. Table 3 shows the evaluation results of the laminate. Table 3 also shows the evaluation results of the interlayer adhesion using a separately prepared laminated sheet having the same two-layered structure.

### Example 2

A laminate was prepared in a manner similar to Example 1, except that the resin composition (1-2) was used instead of the resin composition (1-1) of Example 1. Table 3 shows the evaluation results of the laminate. Table 3 also shows the evaluation results of the interlayer adhesion using a separately prepared laminated sheet having the same two-layered structure.

### Example 3

A laminate was prepared in a manner similar to Example 1, except that the resin composition (1-3) was used instead of the resin composition (1-1) of Example 1. Table 3 shows the evaluation results of the laminate. Table 3 also shows the evaluation results of the interlayer adhesion using a separately prepared laminated sheet having the same two-layered structure.

### Example 4

A laminate was prepared in a manner similar to Example 1, except that the resin composition (1-4) was used instead of the resin composition (1-1) of Example 1. Table 3 shows the evaluation results of the laminate. Table 3 also shows the evaluation results of the interlayer adhesion using a separately prepared laminated sheet having the same two-layered structure.

### Example 5

A laminate was prepared in a manner similar to Example 1, except that the resin composition (1-5) was used instead of the resin composition (1-1) of Example 1. Table 3 shows the evaluation results of the laminate. Table 3 also shows the evaluation results of the interlayer adhesion using a separately prepared laminated sheet having the same two-layered structure.

### Example 6

A laminate was prepared in a manner similar to Example 1, except that the resin composition (1-6) was used instead of the resin composition (1-1) of Example 1. Table 3 shows the evaluation results of the laminate. Table 3 also shows the evaluation results of the interlayer adhesion using a separately prepared laminated sheet having the same two-layered structure.

### Comparative Example 1

A laminate was prepared in a manner similar to Example 1, except that the resin composition (1′) was used instead of the resin composition (1-1) of Example 1. Table 3 shows the evaluation results of the laminate. Table 3 also shows the evaluation results of the interlayer adhesion using a separately prepared laminated sheet having the same two-layered structure.

### Comparative Example 2

A laminate was prepared in a manner similar to Example 1, except that a methacrylate resin was used instead of the resin composition (1-1) of Example 1. Table 3 shows the evaluation results of the laminate. Table 3 also shows the evaluation results of the interlayer adhesion using a separately prepared laminated sheet having the same two-layered structure,

### Comparative Example 3

A laminate was prepared in a manner similar to Example 1, except that the SMA resin (A) was used instead of the resin composition (1-1) of Example 1. Table 3 shows the evaluation results of the laminate. Table 3 also shows the evaluation results of the interlayer adhesion using a separately prepared laminated sheet having the same two-layered structure.

TABLE 3

| | | Total | | Pencil | | |
|---|---|---|---|---|---|---|
| | | light | Warpage | scratch | | |
| | First layer | transmittance | variation | hardness | Interlayer | Bending |
| | composition | (%) | (mm) | (—) | adhesion | workability |
| Example 1 | Resin | 90 | 0 | F | B | Δ |
| | composition | | | | | |
| | (1-1) | | | | | |
| Example 2 | Resin | 90 | 0 | F | B | Δ |
| | composition | | | | | |
| | (1-2) | | | | | |
| Example 3 | Resin | 91 | 0.1 | F | A | ∘ |
| | composition | | | | | |
| | (1-3) | | | | | |
| Example 4 | Resin | 90 | 0.1 | F | B | Δ |
| | composition | | | | | |
| | (1-4) | | | | | |
| Example 5 | Resin | 91 | 0.4 | F | A | ∘ |
| | composition | | | | | |
| | (1-5) | | | | | |
| Example 6 | Resin | 91 | 0.5 | F | A | ∘ |
| | composition | | | | | |
| | (1-6) | | | | | |
| Comparative | Resin | 91 | 0.9 | H | A | ∘ |
| Example 1 | composition | | | | | |
| | (1′) | | | | | |
| Comparative | Methacrylate | 91 | 2.0 | 2H | A | ∘ |
| Example 2 | resin | | | | | |
| Comparative | SMA resin | 90 | 0 | HB | C | x |
| Example 3 | (A) | | | | | |

### Reference Example 1

The resin composition (1-1) was placed in a rectangular mold frame with a short side of 110 mm and a long side of 150 mm, and was pressed for five minutes at 230° C. and 50 kg/cm², thereby preparing a sheet having a thickness of 2 mm, a short side of 110 mm, and a long side of 150 mm. Table 4 shows the evaluation results of the sheet.

### Reference Example 2

A sheet was prepared in a manner similar to Reference Example 1, except that the resin composition (1-1) was replaced by the resin composition (1-2). Table 4 shows the evaluation results of the sheet.

### Reference Example 3

A sheet was prepared in a manner similar to Reference Example 1, except that the resin composition (1-1) was replaced by the resin composition (1-3). Table 4 shows the evaluation results of the sheet.

### Reference Example 4

A sheet was prepare in a manner similar to Reference Example 1, except that the resin composition (1-1) was replaced by the resin composition (1-4). Table 4 shows the evaluation results of the sheet.

### Reference Example 5

A sheet was prepared in a manner similar to Reference Example 1, except that the resin composition (1-1) was replaced by the resin composition (1-5). Table 4 shows the evaluation results of the sheet.

### Reference Example 6

A sheet was prepared in a manner similar to Reference Example 1, except that the resin composition (1-1) was replaced by the resin composition (1-6). Table 4 shows the evaluation results of the sheet.

### Reference Example 7

A sheet was prepared in a manner similar to Reference Example 1, except that the resin composition (1-1) was replaced by the resin composition (1′). Table 4 shows the evaluation results of the sheet.

### Reference Example 8

A sheet was prepared in a manner similar to Reference Example 1, except that the resin composition (1-1) was replaced by a methacrylate resin. Table 4 shows the evaluation results of the sheet

### Reference Example 9

A sheet was prepared in a manner similar to Reference Example 1, except that the resin composition (1-1) was replaced by the SMA resin (A). Table 4 shows the evaluation results of the sheet.

TABLE 4

| | | | Glass- | Water |
|---|---|---|---|---|
| | | Total light | transition | absorption |
| | | transmittance | temperature | at saturation |
| | | (%) | (° C.) | (%) |
| Reference | Resin | 91 | 136 | 0.9 |
| Example 1 | Composition | | | |
| | (1-1) | | | |
| Reference | Resin | 91 | 135 | 0.9 |
| Example 2 | Composition | | | |
| | (1-2) | | | |
| Reference | Resin | 91 | 132 | 1.1 |
| Example 3 | Composition | | | |
| | (1-3) | | | |
| Reference | Resin | 90 | 142 | 0.9 |
| Example 4 | Composition | | | |
| | (1-4) | | | |
| Reference | Resin | 91 | 128 | 1.2 |
| Example 5 | Composition | | | |
| | (1-5) | | | |
| Reference | Resin | 91 | 130 | 1.3 |
| Example 6 | Composition | | | |
| | (1-6) | | | |
| Reference | Resin | 91 | 123 | 1.6 |
| Example 7 | Composition | | | |
| | (1′) | | | |
| Reference | Methacrylate | 93 | 110 | 7.1 |
| Example 8 | Resin | | | |
| Reference | SMA Resin | 91 | 138 | 0.8 |
| Example 9 | (A) | | | |

The sheets (Reference Examples other than Reference Example 6) composed of the resin composition (1), (1′) or the SMA resin (A), which are used as the laminate of the present invention, have a higher glass-transition temperature and a lower water absorption at saturation than those of the sheet (Reference Example 6) composed of methacrylate resin. It is estimated that the high glass-transition temperature and the low water absorption at saturation of the sheets composed of the resin composition (1), (1′) or the SMA resin (A) are obtained due to the suppression of the occurrence of warpage of the laminate of the present invention in hot and humid environments. The laminate using the resin composition (1′) (Comparative Example 1) and the laminate using methacrylate resin (Comparative Example 2) are not sufficient enough to suppress the occurrence of warpage in hot and humid environments. Further, the laminate using the SMA resin (A) (Comparative Example 3) has a low surface hardness, and the interlayer adhesion between the layer composed of the SMA resin (A) and the layer composed of polycarbonate is poor, which leads to deterioration in bending workability.

In comparison with this, the laminate composed of the resin composition (1) in which a specific amount of methacrylate resin is added to the SMA resin (A) has an improved surface hardness and bending workability, while suppressing the occurrence of warpage in hot and humid environments.

Further, in comparison with the laminate (Example 3) using the SMA resin (B), the laminate (Example 2) using the SMA resin (A) has an improved transparency, as well as an improved interlayer adhesion and bending workability.

Thus, the laminate of the present invention can drastically improve a warpage variation, without deteriorating various performances of the conventional laminate of methacrylate resin and polycarbonate.

### INDUSTRIAL APPLICABILITY

A laminate according to the present invention is characterized by being well-balanced in transparency, abrasion resistance, bending workability, and the like, while suppressing the occurrence of warpage in hot and humid environments, and therefore the laminate is suitably used for a cover or a housing of a display device, a window material or a cover on both the interior and exterior of a vehicle, and the like.

### REFERENCE SIGNS LIST

1 LAYER (FIRST LAYER) INCLUDING RESIN COMPOSITION (OR METHACRYLATE RESIN OR SMA RESIN)

2 POLYCARBONATE MONOLAYER SHEET (SECOND LAYER)

3 ALMINUM BOARD

1. A laminate comprising:
a layer comprising a resin composition containing a methacrylate resin and a copolymer comprising at least a structural unit derived from an aromatic vinyl compound represented by the following general formula (a) and a structural unit derived from an acid anhydride represented by the following general formula (b), wherein a mass ratio of methacrylate resin/copolymer is in a range from 50/50 to 5/95; and
a layer comprising polycarbonate 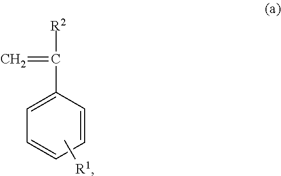
wherein R¹ and R² independently represent a hydrogen atom or an alkyl group 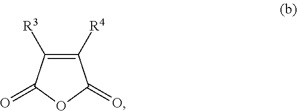
and
wherein R³ and R⁴ independently represent a hydrogen atom or an alkyl group.

2. The laminate according to claim 1, wherein the copolymer contains 50 to 85 mass % of a structural unit derived from an aromatic vinyl compound (a), and contains 15 to 50 mass % of a structural unit derived from acid anhydride (b).

3. The laminate according to claim 1, wherein the copolymer contains 50 to 84 mass % of a structural unit derived from aromatic vinyl compound (a), 15 to 49 mass % of a structural unit derived from an acid anhydride (b), and 1 to 35 mass % of a methacrylate ester monomer.

4. The laminate according to claim 3, wherein the methacrylate ester monomer is methyl methacrylate.

5. The laminate according to claim 1, further comprising an abrasion-resistant layer formed on at least one surface of the laminate.

6. The laminate according to claim 1, wherein the resin composition has a glass-transition temperature in a range from 120 to 160° C.

7. The laminate according to claim 1, wherein the copolymer has a weight average molecular weight in a range from 40,000 to 300,000.

8. The laminate according to claim 1, wherein the layer comprising the resin composition and the layer comprising polycarbonate are directly in contact with each other.

9. The laminate according to claim 1, wherein the laminate is a molded body molded by multilayer extrusion molding.
